(19) United States
(12) Patent Application Publication
(10) Pub. No.: US 2002/0112590 A1
(43) Pub. Date: Aug. 22, 2002

(54) Tree felling disc saw with replaceable teeth

(76) Inventors: Stephan E. Bohner, Woodstock (CA); Andrew R. Hoshel, Brantford (CA); Duane A. Barlow, Brantford (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 09/785,337

(22) Filed: Feb. 20, 2001

(51) Int. Cl. B27B 5/00

(52) U.S. Cl. 83/840; 83/676; 83/839

(57) ABSTRACT

The disc saw blade has a plurality of teeth detachably mounted in sockets provided in a rim portion around the circumference thereof. Each tooth has an anchoring portion, and a cutting edge which projects slightly from the circumference of the saw blade. The sockets each have an anchor-receiving portion to receive the anchoring portion of a tooth. The teeth and the sockets are configured such that each tooth is installed by inserting its anchoring portion into a corresponding anchor-receiving portion of a socket, in an axial direction, and then securing the tooth to prevent axial removal, for example by making the anchoring portion cylindrical and rotating the tooth rearwardly about a center of the cylindrical anchoring portion to position a keyway on a key portion extending into the socket, or by using a bolt threaded into or through the tooth. Radial removal is prevented by the anchoring portion being shaped such that it cannot be extracted from the anchor-receiving portion, except axially. For example, in the cylindrical anchor version, the anchoring portion is more than 180 degrees engaged within the cylindrical anchor-receiving portion of the socket. A bolt, pin or the like may be used to secure the tooth in its installed position. A small throw gap is achieved, and a large gullet is provided by each socket for wood chip clearance.

### BACKGROUND OF THE INVENTION

This invention relates to tree felling heads, for cutting and harvesting trees, particularly those heads of the type using circular saw blades having replaceable teeth, and particularly to the circular saw blade and the replaceable teeth.

Tree felling disc saws such as first described in U.S. Pat. Nos. 4,445,552 (Hyde) and 4,491,163 (Kurelek) and later modified by, amongst others, U.S. Pat. Nos. 5,377,731 (Wildey) and 5,085,112 (MacLennan), are constructed to be unusually sturdy (e.g. 1 inch thick) and to cut an unusually wide kerf (e.g. 2-inches thick). The sturdiness is necessary to allow relatively poorly controlled machine travel or knuckle boom reach to be used to feed the saw through the tree. This requires a thick blade to resist bending from errant feed motion, and accordingly a wide kerf to give clearance for the blade in the cut. In addition, after the tree is cut, the designs are necessarily such that the butt of the still vertical tree does not rest on any top surface of the rotating saw, but on a fixed butt plate which is recessed into the saw, as illustrated for example in U.S. Pat. No. 5,794,674 (Kurelek). The saw's kerf must be wide enough to allow entrance of the combined thickness of this butt plate and the rotating blade and still have some clearance left over on the bottom for head drop, which occurs as a cut is completed and the weight of the tree is added to what the machinery is supporting.

It is because of these greater strength and wider kerf needs on tree felling applications that thin, commercially available circular crosscut saw blades such as those marketed by Simonds, with for example a ¼ inch blade and 7/16 inch kerf, could not be applied to tree felling. Some early tree felling machines temporarily solved the disc strength and wide kerf needs by crudely fabricating saws with integral teeth, similar to some inexpensive crosscut saws, but from approximately one-inch thick steel plate and with alternate teeth bent up and down to cut a two-inch kerf (see for example U.S. Pat. No. 4,270,586 (Hyde et al.)).

It was thought that toughness on the job to protect against breakage from encounters with rocks was a most essential feature and that if the cutting points dulled they could be touched up with a grinder or even rebuilt by welding many times during the life of the relatively expensive steel disc. However, it soon became obvious that loggers tended not to take the time to rebuild and sharpen teeth and were running with such dull saws that power consumption was high, productivity was low and blade stresses so high that cracking at the gullets was occurring.

As it became apparent that loggers would pay more for a saw with replaceable, keener cutting teeth, various “bolt-on” ideas were devised and used. Some examples can be seen in U.S. Pat. Nos. 4,750,396 (Gaddis), 4,563,929 (Ringlee), 5,085,112 (MacLennan), 5,303,752 (MacLennan), 4,879,936 (Anderson), 5,211,212 (Carlson et al.), Des. 320,542 (Gilbert), 5,377,731 (Wildey) and 4,932,447 (Morin). Although these devices sever trees from the stump well and some are relatively easy to maintain, they all have various drawbacks, including some which are safety-related. Some have many parts (as many as six per tooth) which can potentially be thrown if those threaded fasteners wear out, unscrew or break.

Others with fewer parts, such as in U.S. Pat. Nos. 5,377,731 (Wildey) and 4,932,447 (Morin), have large gaps between teeth where the ends of sticks of wood can enter and be thrown. Manufacturing clearance requirements dictate the apparently excessive gap of these saws. U.S. Pat. No. 4,446,897 (Kurelek) showed a taper-held replaceable tooth in a continuous rim, but an optimal method of holding such teeth in place against cutting forces was never devised. U.S. Pat. No. 5,261,306 (Morey et al.), is exceptional in providing reduced throw probability by having a saw blade periphery advantageously contoured with bumps to at least effectively reduce the throw gap between teeth at the circumference, but tooth retention is very dependent on a threaded fastener.

FIGS. 15 and 16 (prior art) illustrate the throw gap which results from several typical prior art shank and bolt tooth attachment methods. FIG. 15 shows the blade from above, and FIG. 16 shows the blade edge-on. It is known that a tangentially oriented wooden stick, somehow accidentally and rapidly fed at the saw rim of teeth, can be dangerously thrown if a radial face of a moving saw tooth can contact sufficient of the stick end grain area to instantly accelerate it to tooth tip velocity without cutting or fracturing out a relatively harmless chip of wood. The exact values of such numbers as saw rpm, tooth velocity, stick size, stick density and weight and the engagement area at which throwing rather than cutting occurs are virtually impossible to calculate and design against. However, it is reasonable to predict that for any given saw speed, the greater the gap between the face of a tooth and the back of the previous passing tooth, the more likely it is that a stick end will occasionally enter the gap sufficiently to be thrown. A stick might enter a gap from either the top or the bottom or the circumference of a saw toothed rim. It is also evident that near horizontal or tangential stick angles would most likely result in a spear-like throw if the saw does not break a chip out of the stick. A continuous smooth rim which would not be able to throw cannot be used because at least enough gap needs to be provided as a gullet to accept the wood chips being cut loose and to carry them out of the cut for expulsion.

There has thus been a need for a felling saw blade that would have a relatively smooth circumference with only enough tooth protrusion to do its share of cutting and enough gullet gap to carry its wood chips out of the kerf in the tree. In such a blade, the tooth retention method should not depend solely on threaded fasteners, and wear in excess of normal such as might occur on poorly maintained machines should not result in tooth parts or tooth holders being thrown, but rather the saw should merely cease to cut at a sufficiently productive rate, so that new teeth will have to be installed. U.S. patent application Ser. No. 09/179,547 (allowed) and corresponding Canadian patent application no. 2,251,902, both filed Oct. 28, 1998, describe a “C-tooth” which provides one solution to this particular problem. The present invention provides another.

Another desirable aspect of an ideal saw blade is that it would allow “felling on the go”, i.e. continuous felling of a number of trees without stopping between cuts. However, to be able to do this, highly efficient teeth are required, with effective gullets for clearance of wood chips, so that saw rpm does not decline excessively with each cut. Putting such a load on the butt plate that it is pinched down onto the saw blade must also be avoided, since this of course causes a loss of blade energy, in addition to causing excessive wear. Avoiding an excessive load on the butt plate is difficult, since the felling head must be tilted slightly downwardly so that the required skirt at the rear of the blade housing will clear the stump of the just-felled tree as the feller head moves forward to the next tree.

Loss of blade energy, whether due to inefficiency of the saw teeth or due to butt plate pinching, or a combination of those factors, of course prevents felling on the go, in addition to increasing operating costs due to wasted energy. The operator must stop cutting after just several trees, to allow the saw to recover its rpm and energy, and thus is unable to take full advantage of the felling head's bunching and accumulation capabilities, i.e. its ability to hold multiple trees.

### SUMMARY OF THE INVENTION

In view of the preceding, it is an object of the invention to provide an improved tree felling head, using a saw with a saw blade with teeth which are readily replaceable but securely installed. The teeth constitute the most significant early wear elements, so that replacement of the teeth restores the blade to nearly-new condition, for a longer safe service life than is typical in the prior art.

The invention therefore provides teeth that are inserted into sockets in the blade axially, i.e. in a direction parallel to the axis of rotation of the blade, such that there are no forces arising from normal operation affecting tooth retention, greatly reducing the risk of tooth parts being thrown during tree and brush cutting. Furthermore, to provide a throw gap which is as small as possible, the teeth preferably have tips with only enough protrusion beyond the rim as is necessary for cutting, and the rim preferably is as smooth and continuous as possible. A large gullet is however provided in the sockets adjacent to each tooth, to provide for wood chip clearance.

More specifically, the invention uses replaceable teeth which are detachably mounted in sockets provided in a rim portion around the circumference of the disc saw blade. Each tooth has an anchoring portion and at least one cutting edge projecting slightly from the circumference of the disc saw blade. The teeth and the sockets having complementary configurations such that the teeth are installed by inserting their respective anchoring portions in an axial direction into correspondingly-shaped respective anchor-receiving portions of the sock, removed of the teeth in a direction other than axially then being prevented by the anchoring portions of the teeth being shaped such that they cannot be extracted in a direction other than axially from the anchor-receiving portions of the sockets. For example, the anchoring portion can be cylindrical and can be more than 180 degrees engaged within the correspondingly cylindrical anchor-receiving portion of the socket. Other shapes as described later herein can also be used, the essence being that their shapes are such that they are trapped except against axial movement.

Means are provided for preventing axial removal of the teeth once installed. For example, in one embodiment, each tooth has a keyway on a rear face thereof to engage a key portion extending from the saw disc into the socket opening. The teeth and the sockets are configured such that each tooth is installed by inserting its cylindrical anchoring portion into a corresponding cylindrical anchor-receiving portion of a socket, in an axial direction, and then securing it against axial motion by rotating the tooth rearwardly about a center of the cylindrical anchoring portion to position the keyway on the key portion. In other embodiments, as described in detail herein, bolts or pins or the like are used to prevent axial removal.

The invention provides a robust circular saw blade for cutting a wide kerf as is necessary in high-speed tree felling, the teeth being of a size sufficient to cut a kerf of sufficient width to accommodate the rim with only a small clearance as the blade advances. The efficiency of the teeth, and the large gullets, minimize energy loss during cutting, thereby facilitating felling on the go. That, combined with minimizing the tendency of the butt plate to be pinched onto the upper surface of the blade, enables the operator to maintain an acceptable saw rpm much longer than was possible previously.

In the preferred embodiment, the tendency for the butt plate to be pinched onto the upper surface of the blade is reduced by providing a recess in the upper surface of the blade, with the butt plate being positioned at least partially in that recess, and preferably with its upper surface below the saw kerf.

It is a further advantage of the invention that the saw, with its relatively smooth outer periphery, has noticeably less windage loss (i.e. aerodynamic drag) than most prior art saws.

Further features of the invention will be described or will become apparent in the course of the following detailed description.

### BRIEF DESCRIPTION OF THE DRAWINGS

The invention will now be described in detail with reference to the accompanying drawings of the preferred embodiment by way of example. In these drawings:

FIG. 1 is a perspective view of the preferred embodiment of the blade in the invention;

FIG. 2 is a perspective view showing the first step of installing a tooth, namely moving it axially into a socket;

FIG. 3 is a corresponding perspective view showing the tooth in the proper axial position, ready to be rotated to its final position;

FIG. 4 is a plan view of the preferred embodiment;

FIG. 5 is a partial cross-section, at A-A of FIG. 4;

FIG. 6 is a perspective view of one of the teeth, from the impact side;

FIG. 7 is another perspective view of the tooth, from the rear side;

FIG. 8 is a close-up perspective view of the rim of the blade, showing two of the sockets;

FIG. 9 is a plan view of the rim area of the blade;

FIG. 10 is a cross-section at B-B of FIG. 9;

FIG. 11 is a cut-open perspective view of one of the teeth installed in its socket, showing a locking bolt;

FIG. 12 is a view corresponding to FIG. 11, showing an alternative embodiment of the locking bolt;

FIG. 13 is a perspective view showing another alternative locking means;

FIG. 14 is a perspective view showing yet another alternative locking means;

FIG. 15 (prior art) is a plan view showing a typical “throw gap” in the prior art;

FIG. 16 (prior art) is a side view showing the throw gap;

FIG. 17 is a plan view showing a typical “throw gap” in the invention;

FIG. 18 is a side view showing the throw gap in the invention;

FIG. 19 is a perspective view showing a tooth which is secured against axial movement by a bolt only, i.e. there is no keyway;

FIG. 20 is a perspective view showing a variation on FIG. 19, wherein the bolt extends into a slot in the disc saw blade;

FIG. 21 is a perspective view showing a variation of FIG. 19 or 20, with a non-cylindrical shape of the anchoring of the tooth, as just one example of many different conceivable shapes;

FIG. 22 is a perspective view showing a tooth which is double-edged, i.e. it can be rotated 180 degrees to provide fresh cutting edges when the first cutting edges become dull;

FIG. 23 is a cut-away perspective view corresponding to FIG. 22;

FIG. 24 is a perspective view showing a tooth similar to that of FIG. 22, but which is secured differently;

FIG. 25 is a cut-away perspective view corresponding to FIG. 24;

FIG. 26 is a perspective view showing a tooth similar to that of FIG. 24, but having a different anchoring portion; and

FIG. 27 is a cut-away perspective view corresponding to FIG. 26.

### DETAILED DESCRIPTION OF THE PREFERRED EMBODIMENT

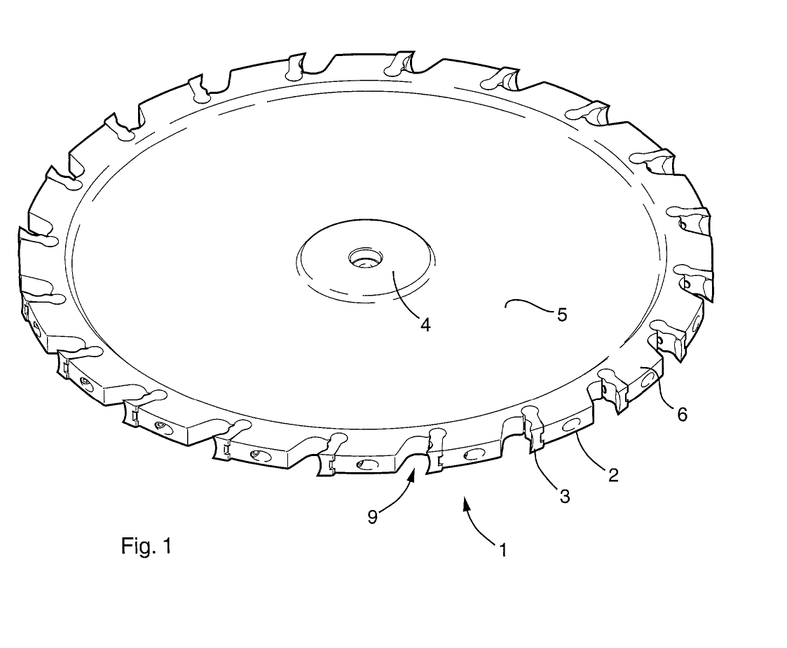

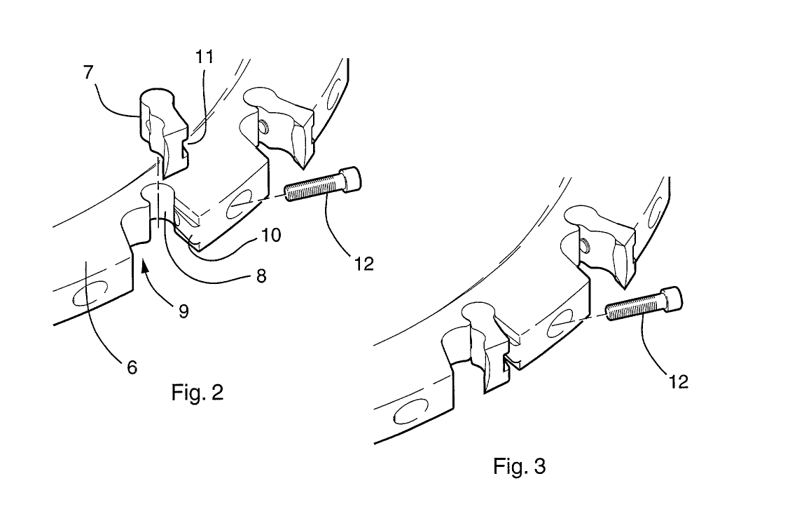

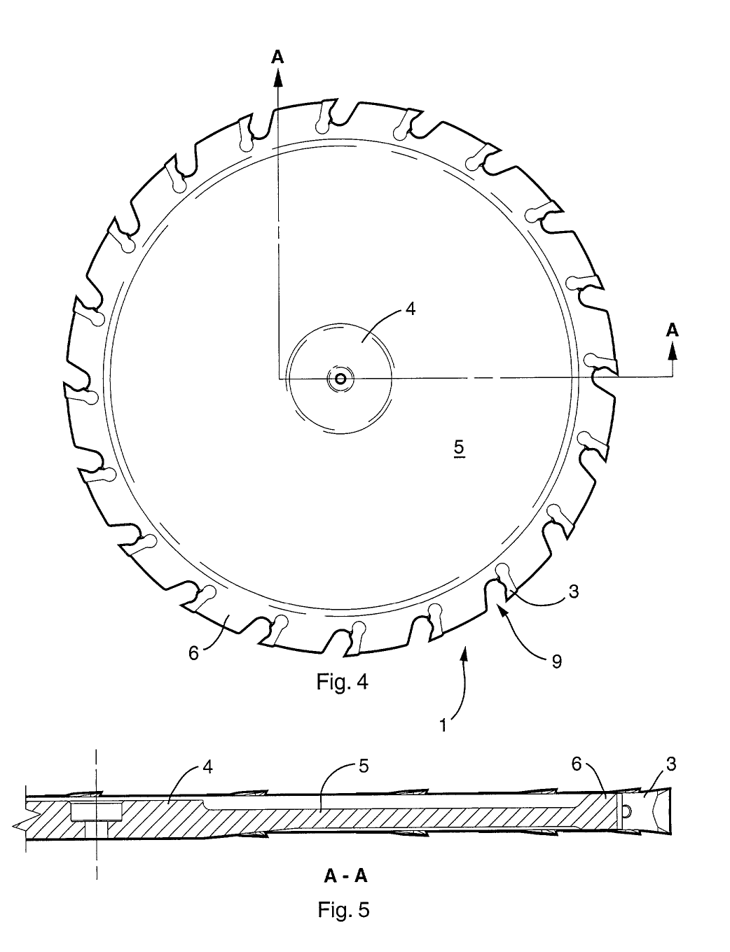

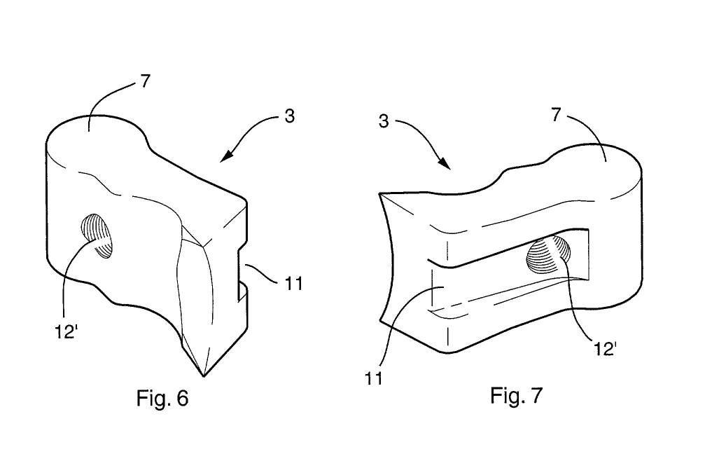

As seen in FIG. 1, the saw blade 1 comprises a disc 2 and multiple removable teeth 3. The disc has an integral hub 4, web 5, and rim 6. As seen more clearly in FIG. 2, the teeth have a cylindrical anchoring portion 7 which fits within a correspondingly-shaped anchor-receiving portion 8 of sockets 9 in the rim 6. The sockets 9 are much larger than necessary for the tooth alone, so as to provide a large gullet area extending inwardly from the rim generally down to the anchor-receiving portion 8, and preferably being at least as wide as the tooth in a circumferential direction. In the preferred embodiment, the rim 6 is substantially thicker than the web 5, at least in the area of the teeth. The hub 4 is a mounting means for bolting the blade to the typical drive means (not shown).

Because of the robust equipment needs for tree felling, the rim 6 at least in the region of the teeth is preferably at least about 1¼ thick and preferably closer to 2 inches thick, i.e. approximately in the range of 30-50 mm. The teeth accordingly are sized to cut a kerf which is even thicker, e.g. about 2⅛ or 2¼ inches for a 1⅞ inch rim. This distinguishes this type of saw from the much flimsier type of crosscut saw mentioned above, where the thickness of the blade around the teeth typically may be only 3/16 to ¼ inches.

In the flimsiest version of the invention for harvesting small trees, the rim at least in the area around the teeth would still typically be at least ¾ inch thick and the kerf would typically be at least 1¼ inches thick to allow room for a butt plate in cases where a butt plate is used, or typically at least 1 inch thick with no butt plate.

Most applications of the invention will require tree gathering and hence a butt plate will be used, but for some applications such as clearing brush or cutting stumps, i.e. applications other than tree harvesting, there is no need for tree gathering. Such applications may not have a butt plate, so narrower kerfs and thinner teeth than customary for tree felling may be used. In other applications, smaller and larger diameter saws will require an even greater range of tooth thicknesses. For example, a very large diameter saw might be used for clearing stumps from previously-logged sites. Such a saw might have a 120-inch diameter, and although no butt plate would be required to support the weight of a tree, the disc thickness and kerf could be say 2 and 3 inches respectively. At the other extreme, for limb and brush clearing, again with no butt plate required, the saw may be only 20 inches in diameter, with a ½ inch blade and rim and a ¾ inch kerf. In such saws, the rim is not necessarily thicker than the web or main body of the blade, i.e. there may be no distinction between the “rim” and the web, in which case “rim” simply means an outer portion of the blade adjacent the circumference. For greater clarity, the expression “rim portion” is used in the claims, to indicate the area adjacent the circumference, regardless of whether or not there is in fact a discrete “rim”.

Other saw disc configurations having various mounting and drive means clearly could employ the invention, such as in the saws of Isley (U.S. Pat. No. 4,738,291), Hamilton (U.S. Pat. No. 4,593,733), or Wildey (U.S. Pat. No. 5,377,731). In addition, the rim portion and sockets could be constructed of segments or holders fastened to a primary disc similar to those as shown, for example, by MacLennan in U.S. Pat. No. 5,058,477. Replaceable holders may be preferred by some for ease of repair of the disc although the addition of detachable parts that could become damaged and thrown is not as desirable as the one-piece disc of the preferred embodiment.

Returning to the preferred embodiment, however, the web 5 is made thinner both for weight reduction and in order to accommodate a butt plate (not shown), as known in the prior art and as shown for example in FIG. 16D of U.S. Pat. No. 5,794,674 (Kurelek). Preferably but not necessarily, this is accomplished by machining the disc to reduce the height of its upper surface inward from the rim, to create a recess sufficient to allow room for the relatively thick butt plate. This is as shown in FIG. 5.

This avoids or minimizes pinching of the butt plate onto the saw blade, partially by permitting a thicker and thus more rigid butt plate, and partially by virtue of the butt plate being relatively low in relation to the kerf. In combination with the efficiency of the teeth in cutting the kerf, this results in reduced energy loss by the blade, and thus improved “felling on the go”.

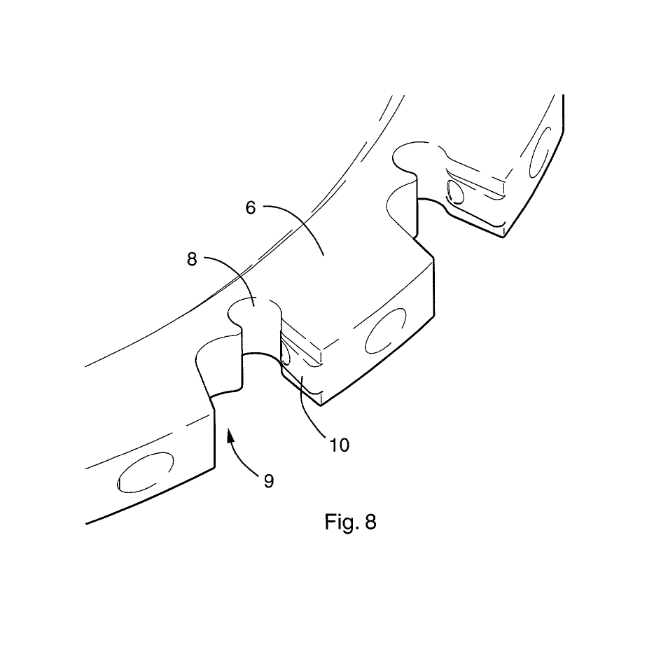

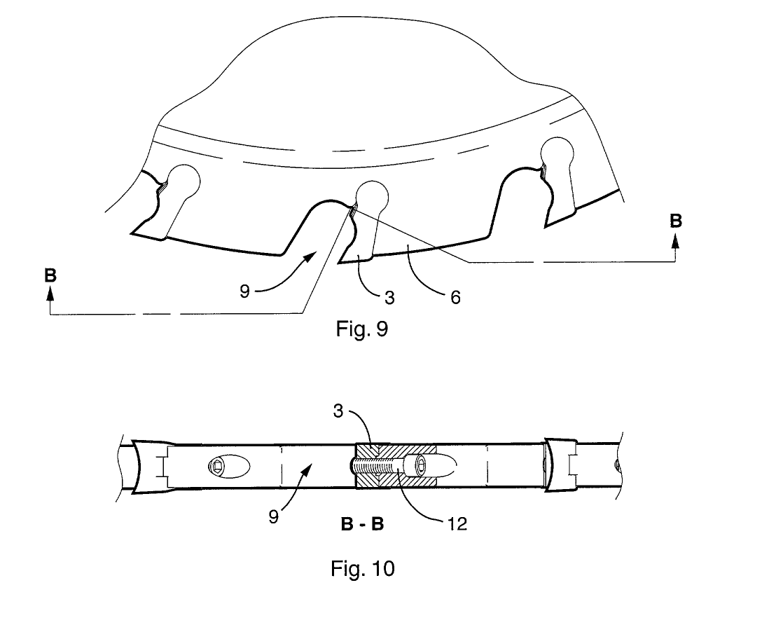

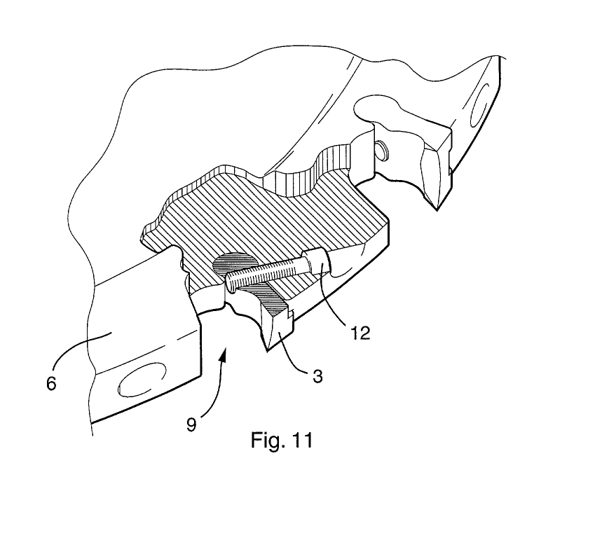

In the preferred embodiment, as shown best in FIGS. 2, 3 and 8, each socket 9 has a male key portion 10 with a generally rectangular cross-section, preferably but not necessarily centered on the plane of the rim, and each tooth 3 has a corresponding female recess 11 to receive the male portion, to ensure and maintain the proper alignment of the tooth relative to the plane of the disc. Alternatively, the male portion could be tapered slightly, i.e. in the form of a truncated triangle, with the female recess correspondingly tapered slightly as well.

Alternative keying means (not illustrated) clearly could be employed. For example, the sockets could have female portions with the teeth having the male portions. Alternatively, one could use a truncated V-shaped key extending from the tooth, or extending from the saw blade. Other shapes obviously also could be used, and it should be clearly understood that the scope of the invention encompasses any and all suitable keying means, not just the preceding. The essence of the invention does not reside in any specific keying means, nor is keying strictly essential, though clearly preferred. Some means sufficient to prevent axial departure of the tooth must be employed, and keying is an effective way to accomplish that, but it can also be accomplished by the use of bolts or pins as described later herein, either on their own or in combination with keying means.

Existing felling saw art uses different shaped cutting tips to suit various tree and ground conditions. Similarly, the teeth in this invention may be variously tipped as desired, although the preferred embodiment as illustrated has a curved configuration (best seen in FIG. 7). The tooth could be strictly in one piece, or could have a carbide tip brazed into a seat (which is still considered a “one-piece” tooth). Even though this does add an item that can be thrown if not carefully attached, there may be a requirement for such carbide tips depending on the soil conditions of the logging site.

FIGS. 2 and 3 show the sequence and the principle of installation of a tooth in its socket. Essentially, the tooth is inserted axially, i.e. from the side of the blade, as shown in FIG. 2, to the position of FIG. 3, and in the preferred embodiment is then rotated into place where the keying comes into play to prevent axial movement. This two-step installation motion in the preferred embodiment provides added security by ensuring that an opposite two-step motion is required in order for a tooth to come off.

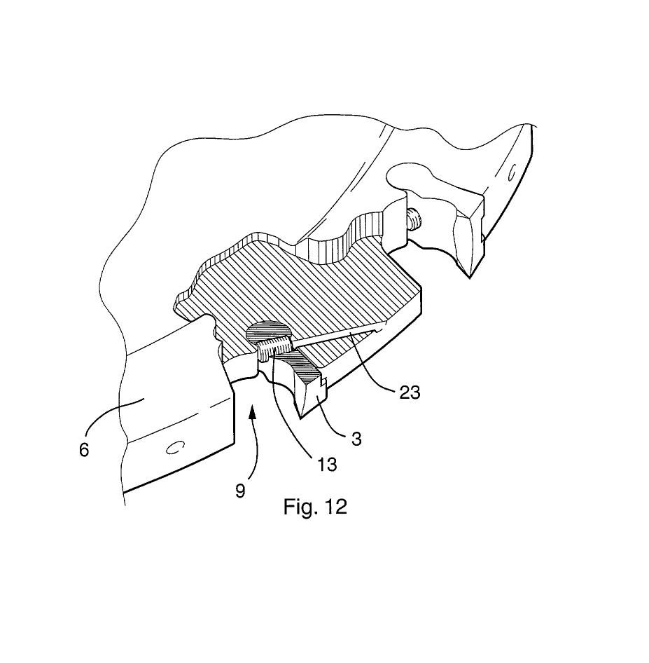

In the preferred embodiment, a bolt 12 is then installed as shown in FIGS. 2, 3 and 11, threaded into a corresponding threaded hole 12′ in the tooth. The bolt is installed to hold the tooth tightly against the back of the socket, not only to prevent the tooth from rotating forward where it could move axially, but also to prevent wear on the socket caused by the tooth moving during normal operation. It is also preferred, but not essential, to have the tip of the bolt protrude slightly into the space used for forward tooth rotation during installation and removal. Thus, in the event of a bolt failure, the tooth cannot rotate forward sufficiently to disengage from the keyway and allow axial motion.

Alternatively, as shown in FIG. 12, a set screw 13 could be positioned in the tooth prior to installation, and rotated to its final position by a tool inserted through an access opening 23. Since the access opening is smaller than the set screw, the set screw cannot be thrown if it comes loose.

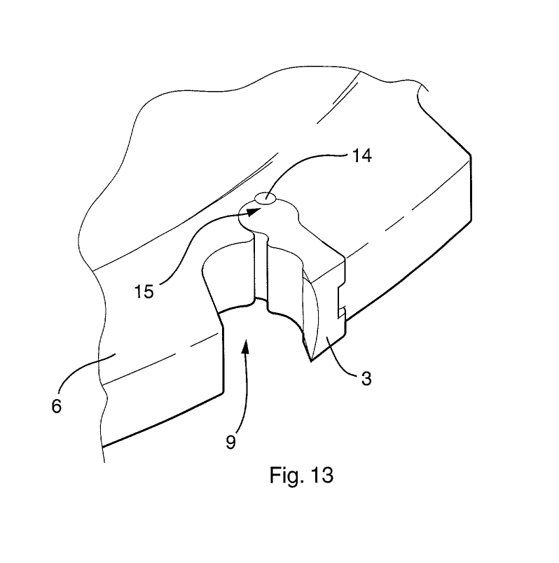

Another means of securing the tooth against rotation is shown in FIG. 13, and consists of installing a pin 14 (preferably a roll pin for example) into a corresponding hole defined between the tooth and its socket when the tooth is in the proper position.

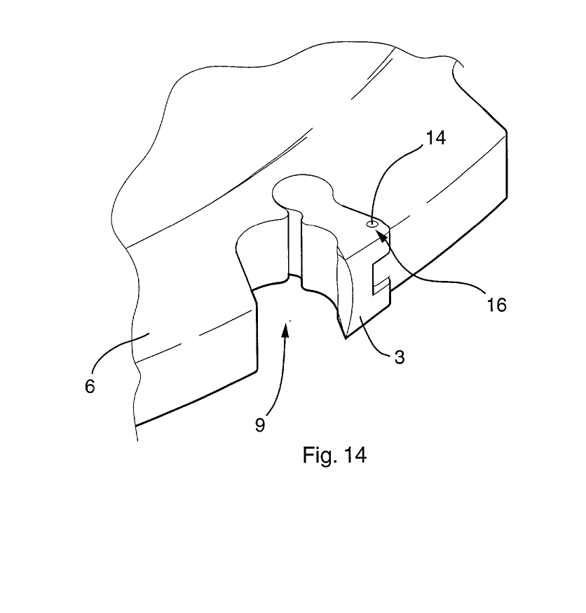

Yet another means of securing the tooth against rotation is shown in FIG. 14, and consists of installing a pin 14 (again preferably a roll pin for example) into a corresponding hole through male and female portions of the keying, these portions being made larger for that purpose.

Of course, it should be appreciated that in all embodiments, the cutting forces are in a direction that will not tend to rotate the tooth away from its proper position in any event, but the greater security of having a bolt or pin or the like is nevertheless highly desirable, and possibly essential from a safety or perceived safety viewpoint. Also, cutting forces, as well as other forces that arise during normal operation, will tend to cause the tooth to move around in its socket, leading to wear of the socket if the tooth is not held fairly rigidly in its installed position. Thus, a fastener of some kind is highly desirable to prevent this motion and the resulting wear.

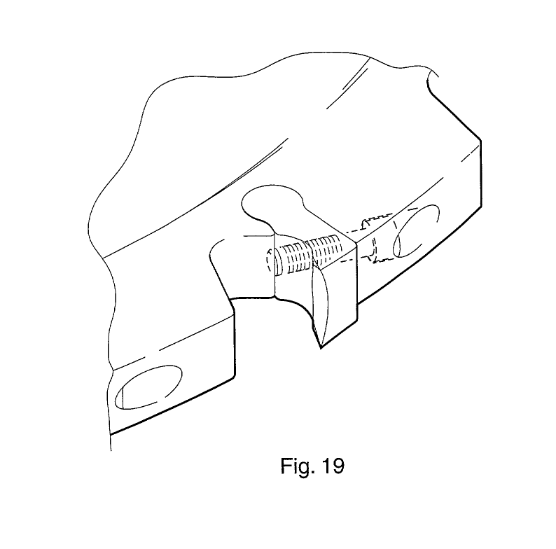

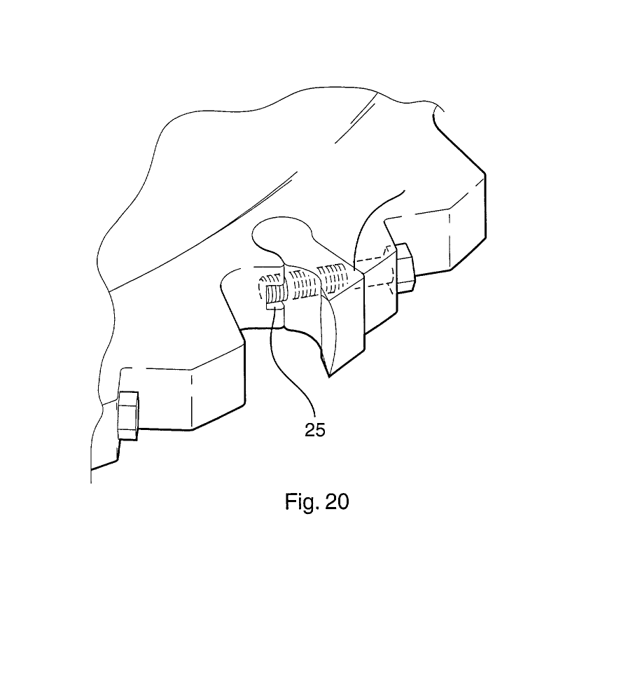

It should also be appreciated that the bolts and pins, etc. as just described can constitute the sole means of preventing axial movement of the teeth, since in general the forces in the axial direction are small compared to those in the radial direction. Examples of such embodiments are shown in FIGS. 19-27. FIG. 19 is a perspective view showing a tooth which is secured against axial movement by a bolt 12 only, i.e. there is no keyway. The bolt head is shown recessed into a hole 12′. FIG. 20 is shows a variation on FIG. 19, wherein the bolt head is exposed, but the bolt extends into a slot 25 in the disc saw blade, so that even if the head of the bolt is broken off, axial movement will still be prevented by the extension of the bolt in to the slot 25.

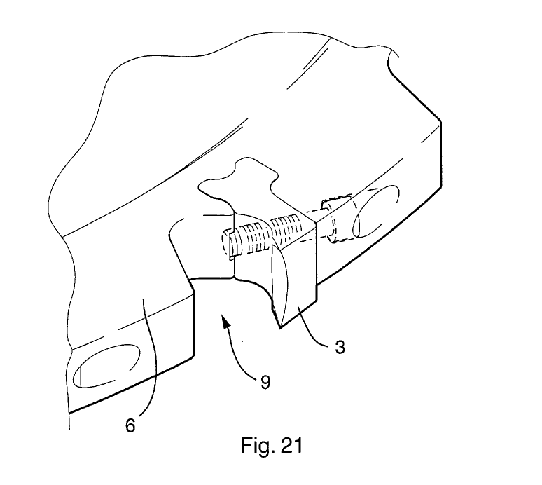

FIG. 21 is a perspective view of another variation of FIG. 19 or 20, with a non-cylindrical shape of the anchoring portion of the tooth, as just one example of many different conceivable shapes. A cylindrical shape is not required, since rotation onto a keyway is not applicable. A non-cylindrical shape may be preferred in such embodiments, since then rotation of the tooth is not necessary, and also not possible.

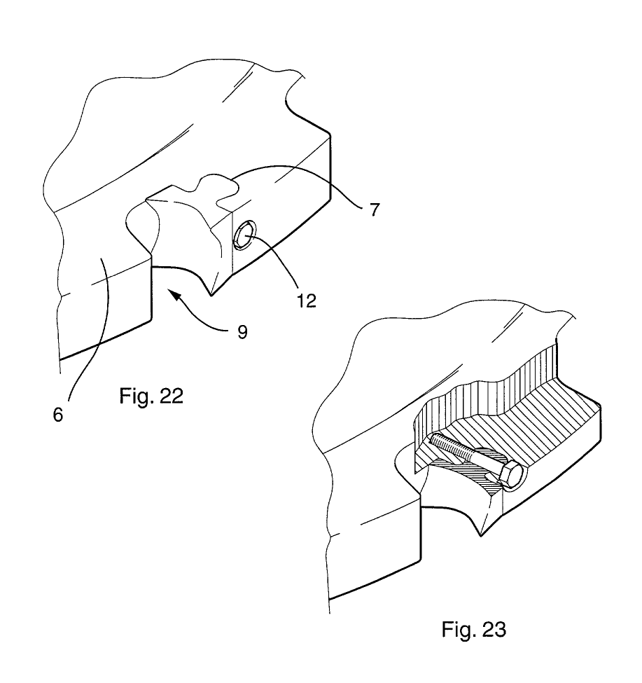

FIGS. 22 and 23 show a tooth which is double-edged, i.e. it can be rotated 180 degrees to provide fresh cutting edges when the first cutting edges become dull. The first cutting edges are along the outer edges as illustrated, with the second cutting edges being along the opposite edges. This embodiment also shows yet another example of the anchoring portion shape. Any shape which provides entrapment except in an axial direction is suitable.

FIGS. 22 and 23 also show that the anchor-receiving portion of the socket need not be at the bottom of the socket; here it is in a generally radial wall of the socket instead. A bolt 12, recessed into an opening 12′, is used to secure the tooth against axial removal. The bolt extends through the anchoring portion of the tooth, and preferably extends beyond the anchoring portion and into a threaded hole in the disc saw blade, though the hole in the anchoring portion could instead be threaded if desired.

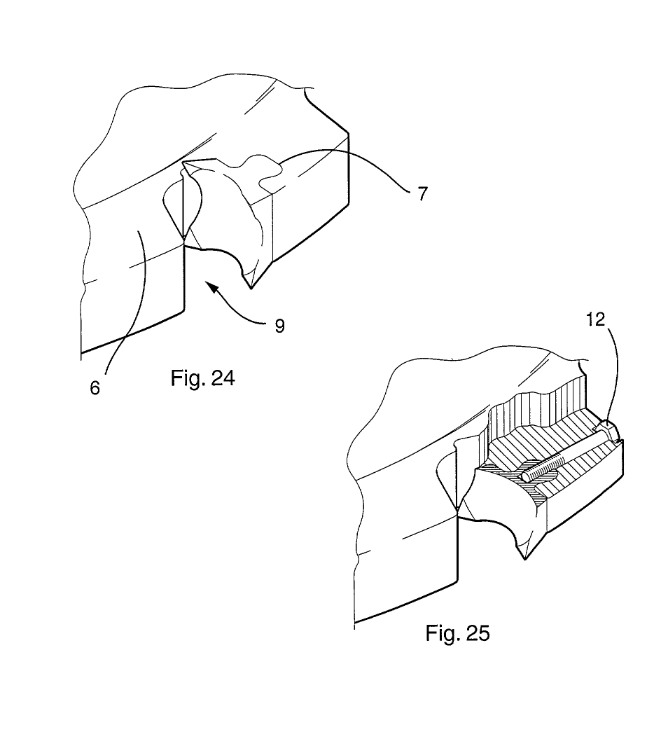

FIGS. 24 and 25 show a tooth similar to that of FIG. 22, but which is secured differently; a bolt 12 extends into the anchoring portion of the tooth in a generally circumferential direction from an adjacent socket.

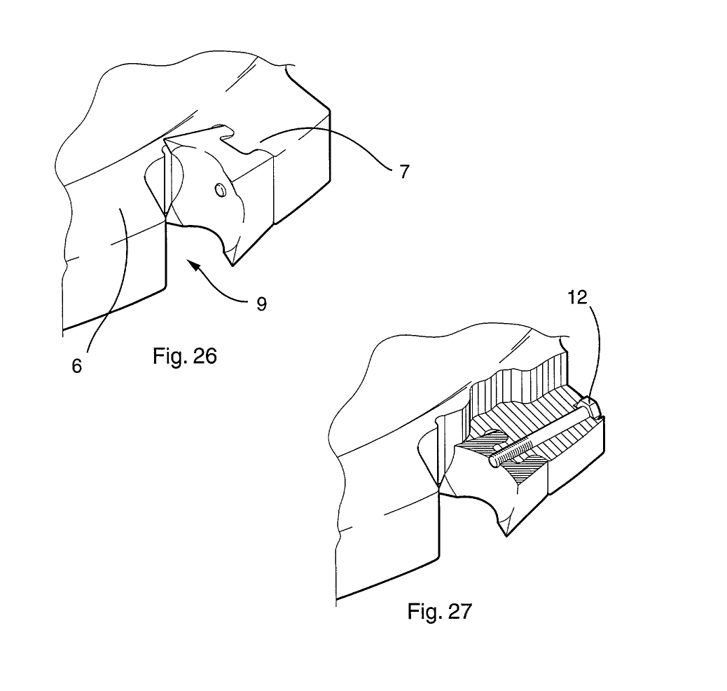

FIGS. 26 and 27 show yet another similar tooth, having a differently-shaped anchoring portion. Again, a bolt 12 extends into the anchoring portion of the tooth in a generally circumferential direction from an adjacent socket.

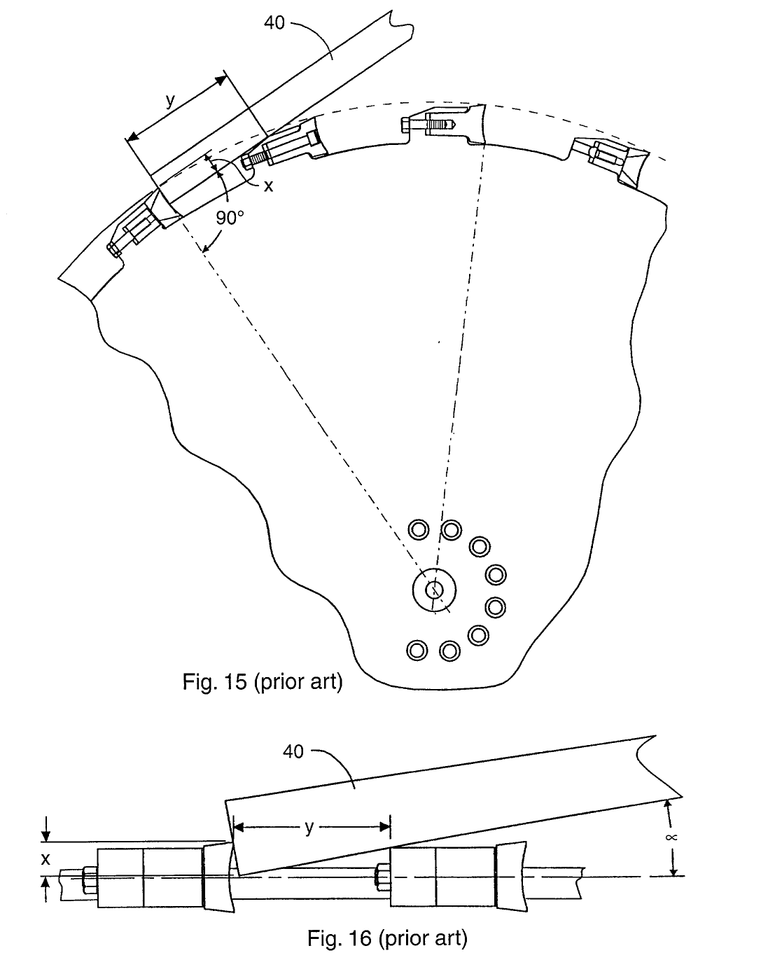

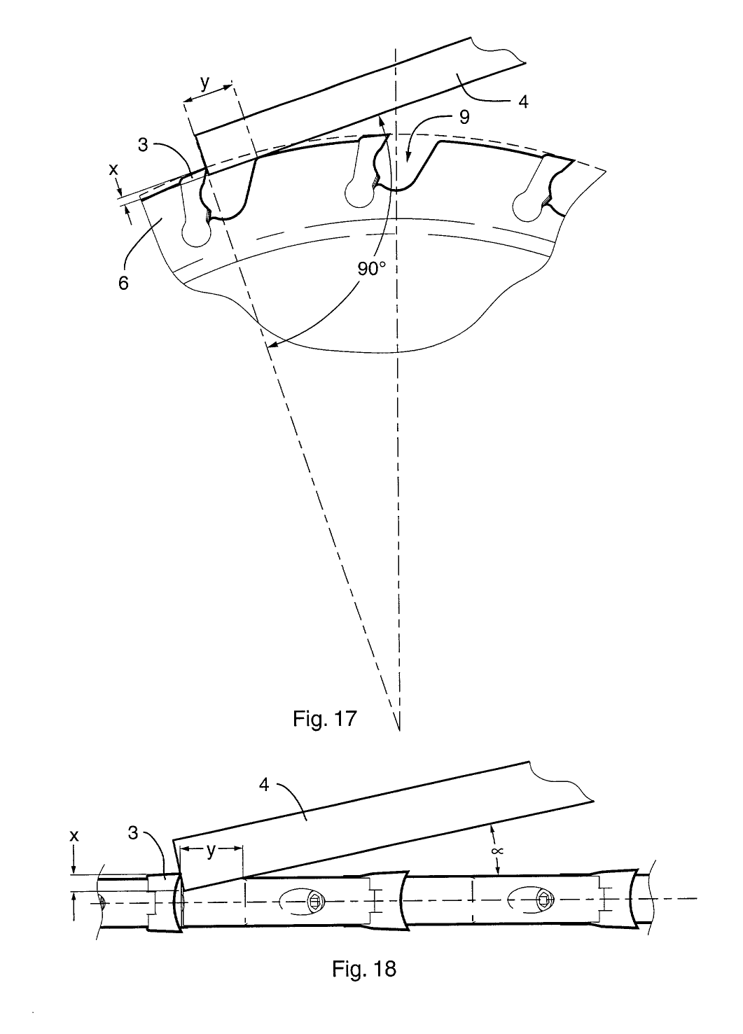

A particular advantage of the invention is that it provides a highly effective solution to the previously described problem of sticks potentially being thrown. As can be seen from the drawings, a very short throw entry gap can be achieved, and with it an end grain engagement chance that is very substantially less than the engagement chance in typical felling saw prior art. FIGS. 17 and 18 show greatly reduced throw entry gaps in both planes when compared to prior art FIGS. 15 and 16, e.g. to possibly less than half an inch engagement x with a stick 40 oriented more or less tangentially in the plane of the saw (FIGS. 15 and 17) or at a small angle a thereto (FIGS. 16 and 18), from typically an inch or more of engagement in the prior art. In the invention, the throw gap y can be less than two inches, and easily less than 3 inches.

A small engagement means that the tooth tends to take a harmless chip out of a stick, without accelerating the stick, whereas a larger engagement can provide enough end grain in compression to transmit sufficient acceleration force to the stick to accelerate it.

In the prior art, the flow of wood chips from the cutting tips in felling saw prior art tooth and blade systems severely wears the area radially inwardly from the tooth tips, resulting in a worn section which normally is part of the blade disc or rim proper, or in some designs part of a tooth holder. Thus replacing worn teeth does not remedy this wear, and after several tooth changes it sometimes becomes necessary for safety to replace the blade or holder as well. By contrast, in the present invention the gullet is very large and extends inwardly a substantial distance, such that the tooth incurs most of the wear, resulting in a significantly longer life for the disc than in the prior art. Although it is difficult to ascribe specific dimensions to the preferred gullet, actual dimensions being a matter of design choice, it may be said that generally the gullet preferably is at least as deep and as long (i.e. in the circumferential direction) as the disc saw's kerf width.

When a threaded fastener is employed, it is advantageous to have the threads in the tooth, as in the preferred embodiment of the invention, rather than being in the blade. Every tooth change causes slight wear on the threads, which can eventually lead to failure of the threads. Having the threads in the tooth means that the threads are replaced with every tooth and bolt change. Obviously, it is also preferred to have the threads in the tooth in the event that the bolt is over-tightened, resulting in stripped threads. It is much more economical to replace a tooth than to repair or replace the blade.

Furthermore, having the bolt threads in the tooth means that clearance does not have to be made in the tooth for the head of the bolt, which would weaken it somewhat.

1. A disc saw for tree cutting, comprising a disc saw blade and a plurality of teeth detachably mounted in sockets provided in a rim portion around the circumference of said disc saw blade, said teeth each having an anchoring portion and at least one cutting edge projecting slightly from the circumference of said disc saw blade when said teeth are installed in said sockets, said teeth and said sockets having complementary configurations such that said teeth are installed by inserting their respective anchoring portions in an axial direction into correspondingly-shaped respective anchor-receiving portions of said sockets, removal of said teeth in a direction other than axially then being prevented by said anchoring portions and anchor-receiving portions being shaped such that said teeth cannot be extracted in a direction other than axially from said anchor-receiving portions, said disc saw further comprising locking means for preventing axial removal of said teeth once installed.

2. A disc saw as recited in claim 1, wherein said locking means comprises a bolt installed through a hole in said rim portion, threaded into a hole in said tooth, said hole in said rim portion and said hole in said tooth aligning when said tooth is fully installed.

3. A disc saw as recited in claim 2, wherein said bolt has a portion which extends beyond said tooth into a slot in said disc saw blade, whereby if a head portion of said bolt is broken off, axial removal of said tooth will still be prevented by said portion of said bolt which extends into said slot.

4. A disc saw as recited in claim 1, wherein said locking means comprises a set screw installed in said tooth, accessible by a tool through a hole in an outer edge of said rim portion, threaded into a hole in said tooth, said hole in said rim portion and said hole in said tooth aligning when said tooth is fully installed, said set screw being rotatable by said tool to butt against a wall of said socket within a slot in said socket.

5. A disc saw as recited in claim 1, wherein said locking means comprises a pin secured in a hole defined by respective hole portions in said tooth and in said rim portion, said hole portions aligning to define said hole when said tooth is in its installed position.

6. A disc saw as recited in claim 1, having a throw entry gap at each tooth location of less than 3 inches, where said throw entry gap is defined as the distance from said cutting edge across said socket to said rim portion, measured tangentially to said circumference.

7. A disc saw as recited in claim 6, having a said throw entry gap of less than 2 inches.

8. A disc saw as recited in claim 1, wherein each said socket has a large gullet portion extending inwardly from said rim portion, generally being at least as deep and as long as the disc saw's kerf width.

9. A disc saw as recited in claim 8, having a throw entry gap at each tooth location of less than 3 inches, where said throw entry gap is defined as the distance from said cutting edge across said socket to said rim portion, measured tangentially to said circumference.

10. A disc saw as recited in claim 9, having a said throw entry gap of less than 2 inches.

11. A disc saw as recited in claim 1, wherein said anchoring portions and said anchor-receiving portions are cylindrical, and wherein each said tooth is secured against a rear surface of said socket to prevent axial removal, radial removal being prevented by said cylindrical anchoring portion being more than 180 degrees engaged within said cylindrical anchor-receiving portion of said socket.

12. A disc saw as recited in claim 11, wherein each said tooth has keying means on a rear face thereof engaging complementary keying means in said socket when installed, each said tooth and said sockets being configured such that after each said tooth is installed by inserting its cylindrical anchoring portion into a corresponding cylindrical anchor-receiving portion of said socket, in an axial direction, it is then rotated rearwardly about a center of said cylindrical anchoring portion to engage said keying means on said tooth with said keying means of said socket, whereby axial removal of said tooth is then further prevented.

13. A disc saw as recited in claim 11, wherein said tooth is secured against said rear portion of said socket by a bolt installed through a hole in an outer edge of said rim portion, threaded into a hole in said tooth, said hole in said rim portion and said hole in said tooth aligning when said tooth is fully installed.

14. A disc saw as recited in claim 12, wherein said tooth is secured against said rear portion of said socket by a set screw installed in said tooth, accessible by a tool through a hole in an outer edge of said rim portion, threaded into a hole in said tooth, said hole in said rim portion and said hole in said tooth aligning when said tooth is fully installed, said set screw being rotatable by said tool to butt against a wall of said socket to prevent out-rotation of said tooth.

15. A disc saw as recited in claim 12, wherein said tooth is secured against said rear portion of said socket by a pin secured in a hole defined by respective hole portions in said tooth and in said rim portion, said hole portions aligning to define said hole when said tooth is in its installed position.

16. A disc saw as recited in claim 12, wherein said tooth is secured against said rear portion of said socket by a pin secured in a hole defined by holes through portions of said keying means of said tooth and said rim portion, said holes in said keying portions aligning with each other when said tooth is in its installed position.

17. A disc saw as recited in claim 11, having a throw entry gap at each tooth location of less than 3 inches, where said throw entry gap is defined as the distance from said cutting edge across said socket to said rim portion, measured tangentially to said circumference.

18. A disc saw as recited in claim 17, having a said throw entry gap of less than 2 inches.

19. A disc saw as recited in claim 11, wherein each said socket has a gullet portion extending inwardly from said rim portion generally down to about said cylindrical anchor-receiving portion, and being at least as wide as the tooth in a circumferential direction.

20. A disc saw as recited in claim 19,having a throw entry gap at each tooth location of less than 3 inches, where said throw entry gap is defined as the distance from said cutting edge across said socket to said rim portion, measured tangentially to said circumference.

21. A disc saw as recited in claim 20, having a said throw entry gap of less than 2 inches.

22. A disc saw as recited in claim 12, further comprising securing means installed to prevent out-rotation of said tooth from its installed position.

23. A disc saw as recited in claim 22, wherein said securing means comprises a bolt installed through a hole in an outer edge of said rim portion, threaded into a hole in said tooth, said hole in said rim portion and said hole in said tooth aligning when said tooth is fully installed.

24. A disc saw as recited in claim 22, wherein said securing means comprises a set screw installed in said tooth, accessible by a tool through a hole in an outer edge of said rim portion, threaded into a hole in said tooth, said hole in said rim portion and said hole in said tooth aligning when said tooth is fully installed, said set screw being rotatable by said tool to butt against a wall of said socket to prevent out-rotation.

25. A disc saw as recited in claim 22, wherein said securing means comprises a pin secured in a hole defined by respective hole portions in said tooth and in said rim portion, said hole portions aligning to define said hole when said tooth is in its installed position.

26. A disc saw as recited in claim 22, wherein said securing means comprises a pin secured in a hole defined by holes through portions of said keying means of said tooth and said rim portion, said holes in said keying portions aligning with each other when said tooth is in its installed position.

27. A disc saw as recited in claim 22, having a throw entry gap at each tooth location of less than 3 inches, where said throw entry gap is defined as the distance from said cutting edge across said socket to said rim portion, measured tangentially to said circumference.

28. A disc saw as recited in claim 27, having a said throw entry gap of less than 2 inches.

29. A disc saw as recited in claim 22, wherein each said socket has a gullet portion extending inwardly from said rim portion generally down to about said cylindrical anchor-receiving portion, and being at least as wide as the tooth in a circumferential direction.

30. A disc saw as recited in claim 29, having a throw entry gap at each tooth location of less than 3 inches, where said throw entry gap is defined as the distance from said cutting edge across said socket to said rim portion, measured tangentially to said circumference.

31. A disc saw as recited in claim 30, having a said throw entry gap of less than 2 inches.

32. A disc saw as recited in claim 1,,wherein each said tooth is configured such that it may be installed in either of two orientations at 180 degrees to each other about a circumferentially-oriented axis, to expose one cutting edge in one orientation and another cutting edge in the other orientation.

33. A tooth for installation in a disc saw for tree cutting, said disc saw comprising a disc saw blade and a plurality of sockets provided in a rim portion around the circumference of said disc saw blade, each said tooth having an anchoring portion and an outer portion extending from said anchoring portion with a distal cutting end, said cutting end having a cutting edge projecting slightly from the circumference of said disc saw blade when said tooth is installed in a said socket, each said tooth and said sockets being configured such that each said tooth is installed by inserting its anchoring portion into a corresponding anchor-receiving portion of said socket, in an axial direction, and then securing said tooth against a rear surface of said socket to prevent axial removal, removal of said teeth in a direction other than axially then being prevented by said anchoring portions and anchor-receiving portions being shaped such that said teeth cannot be extracted in a direction other than axially from said anchor-receiving portions.

34. A tooth as recited in claim 33, wherein said anchoring portion is cylindrical.

35. A tooth as recited in claim 34, wherein said tooth is securable against axial movement by said tooth having keying means on a rear face thereof configured to engage complementary keying means in a said socket when installed.

36. A tooth as recited in claim 33, configured such that it may be installed in either of two orientations at 180 degrees to each other about a circumferentially-oriented axis, to expose one cutting edge in one orientation and another cutting edge in the other orientation.
